(19) United States
(12) Patent Application Publication
(10) Pub. No.: US 2007/0187182 A1
(43) Pub. Date: Aug. 16, 2007

(54) Power generating device

(76) Inventor: Ernie Chang, Taichung Heien (TW)

Correspondence Address: TROXELL LAW OFFICE PLLC;SUITE 1404, 5205 LEESBURG PIKE, FALLS CHURCH, VA, 22041, US

(21) Appl. No.: 11/352,216

(22) Filed: Feb. 13, 2006

(51) Int. Cl. F03G 3/00

(52) U.S. Cl. 185/27

(57) ABSTRACT

A power generating device comprising at least a gravity pressurizing device rotatably connected to a base, the power generating device has on its one end a restraining and pressing portion; when the gravity pressuring device is rotated on the base, it pushes the push-pressing portion on one end of a moving-to-and-fro linking member to render moving of the moving-to-and-fro linking member, a power outputting portion on the other end of the moving-to-and-fro linking member outputs energy for supplying energy source for various power equipment.

### BACKGROUND OF THE INVENTION

1. Field of the Invention

The present invention relates to a power generating device which is structurally simple, convenient for operation and cost low. And more particularly to a power generating device input with a small power to make a gravity pressurizing device exert pressure on a moving-to-and-fro linking member for generating stable large power output. The present invention is suitable for supplying energy source for various power equipment.

2. Description of the Prior Art

In recent years, because of the crisis that the energy source of gasoline is going to be exhausted, countries all over the world actively develop the methods to generate electric energy by using the natural resources of wind power, water power, earth heat or solar energy etc. to reduce the speed of exhausting

However, no matter which of the methods including wind power, water power, earth heat or solar energy etc. is used to generate electric energy, the methods have regional limitations; for instance, some areas have weak wind power for years generally, they are unable to generate electric energy by using the wind power. Similarly, some areas have plenty of rains for years generally, hence the solar energy is not effectively applicable, while water power and earth heat can only be acquired in those blessed regions. In view of the above stated, the variant modes are not applicable completely to the regions all over the world.

In this view, to get rid of the above stated defects, the inventor of the present invention makes a power generating device applicable completely to the regions all over the world to generate stable large power output based on his professional experience of years and after hard study, developing as well as improvements.

### SUMMARY OF THE INVENTION

The primary objective of the present invention is to provide a power generating device input with a small power to make a gravity pressurizing device exert pressure on a moving-to-and-fro linking member for generating large power output and thereby generating an energy source.

The secondary objective of the present invention is to provide a power generating device applicable completely to the regions all over the world to generate stable power outputting.

Therefore, in order to achieve the above stated objectives, the power generating device provided in the present invention comprises a base, at least a gravity pressurizing device and at least a moving-to-and-fro linking member. Wherein the gravity pressurizing device is rotatably connected to the base, and has on its one end a restraining and pressing portion. The moving-to-and-fro linking member is provided on one end thereof with a push-pressing portion to make the restraining and pressing portion of the gravity pressurizing device render moving after it presses downwards, a power outputting portion on the other end of the moving-to-and-fro linking member outputs the energy generated by moving of the push-pressing portion.

The present invention will be more apparent after reading the detailed description of the preferred embodiment thereof in reference to the accompanying drawings.

### BRIEF DESCRIPTION OF THE DRAWINGS

FIG. 1 is a perspective view showing the appearance of a first embodiment of the present invention;

FIG. 2 is a perspective schematic view showing the state of use of the first embodiment of the present invention;

FIG. 3 is a schematic view showing the state of use of the first embodiment of the present invention;

FIG. 4 is a perspective view showing another embodiment of the present invention;

FIG. 5 is a side view showing the state when a restraining and pressing rod and a push-pressing portion on a slide member of the first embodiment of the present invention are respectively provided with a magnetic member;

FIG. 6 is a perspective schematic view showing one end of the restraining and pressing rod of the first embodiment of the present invention is provided with a fixed plate;

FIG. 7 is a side view showing another structure of moving-to-and-fro linking member of the first embodiment of the present invention;

FIG. 8 is a schematic view of a second embodiment of the present invention; and

FIG. 9 is a schematic view of a third embodiment of the present invention.

### DETAILED DESCRIPTION OF THE PREFERRED EMBODIMENT

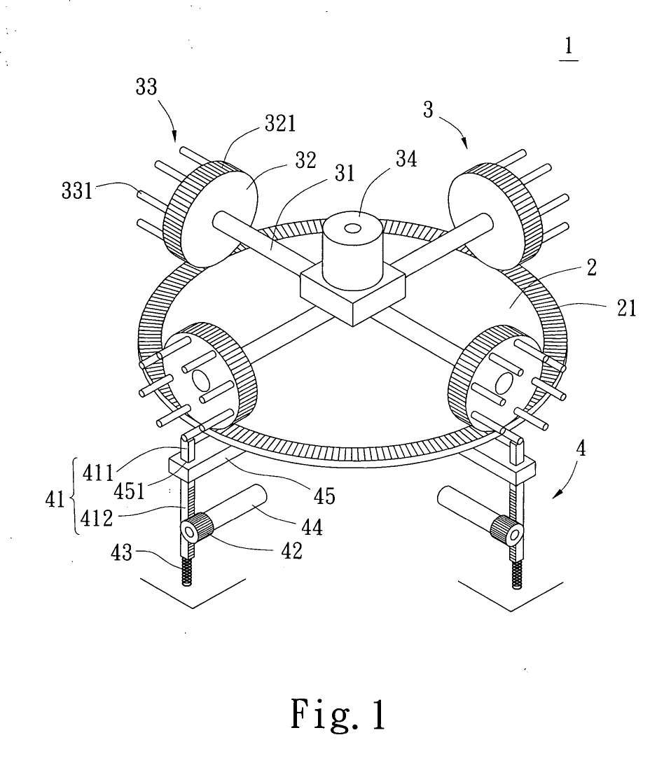

Referring firstly to FIG. 1 showing a first embodiment of a power generating device 1 of the present invention, the power generating device comprises a base 2, at least a gravity pressurizing device 3 and at least a moving-to-and-fro linking member 4.

The base 2 is a fixed round disc, its upper disc surface is provided on its periphery with a first engaging portion 21; the first engaging portion 21 is composed of multiple protruding teeth.

In this embodiment, the number of all the gravity pressurizing devices 3 is four; each gravity pressurizing device 3 includes an axle rod 31 and a restraining and pressing portion 33, the restraining and pressing portion 33 includes a roller 32 and a plurality of restraining and pressing rods 331, the restraining and pressing rods 331 are combined on a lateral surface of the roller 32 and are arranged in a circle. One end of the axle rod 31 is connected to a power inputting device 34 to drive the gravity pressurizing device 3 to roll on the base 2; the power inputting device 34 is provided above the center of the base 2, it can be a motor or some other transmitting mechanism with the same power inputting function. The other end of the axle rod 31 is connected to the roller 32; the roller 32 is preferably a metallic gear to be attracted by gravity to generate downward pressing action. The protruding teeth circling the periphery of the roller 32 function as a second engaging portion 321 to be engaged with the first engaging portion 21 of the base 2 for positioning. The first and the second engaging portions 21, 321 can be in the shape of umbrellas.

In this embodiment, the number of all the moving-to-and-fro linking members 4 is four, but it can be multiple in practical application, the moving-to-and-fro linking member 4 are used cooperatively and respectively with the restraining and pressing portions 33 of the gravity pressurizing devices 3. Each of the moving-to-and-fro linking members 4 includes a moving-to- and-fro slide member 41, a gear 42, an elastic member 43 and a power outputting portion 44; the slide member 41 is an elongate rod, it is restrained in a guiding way 451 to move to and fro in the latter. The upper portion of the slide member 41 is a push- pressing portion 411, while the lower portion of the slide member 41 is a rack 412; the rack 412 is engaged with the gear 42, the lower end of the rack 412 is connected with the elastic member 43 which is a spring; the gear 42 is connected with the power outputting portion 44.

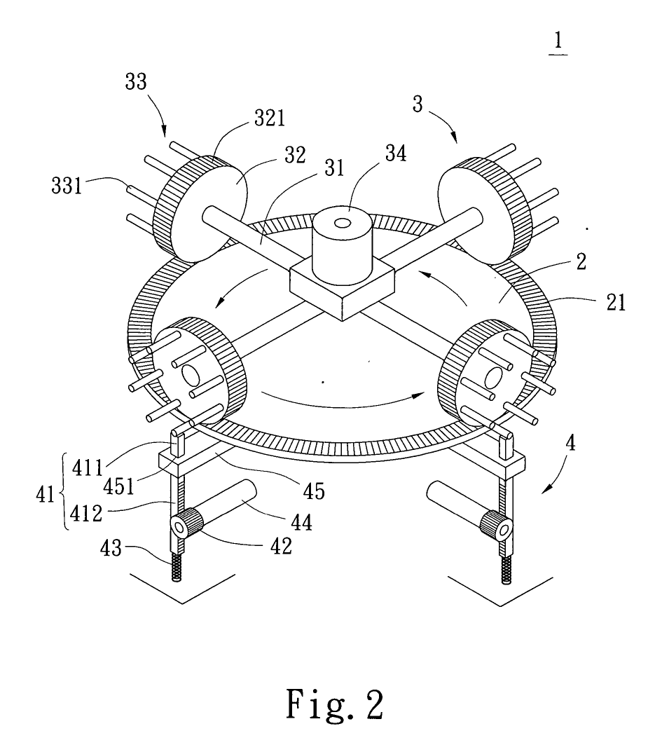

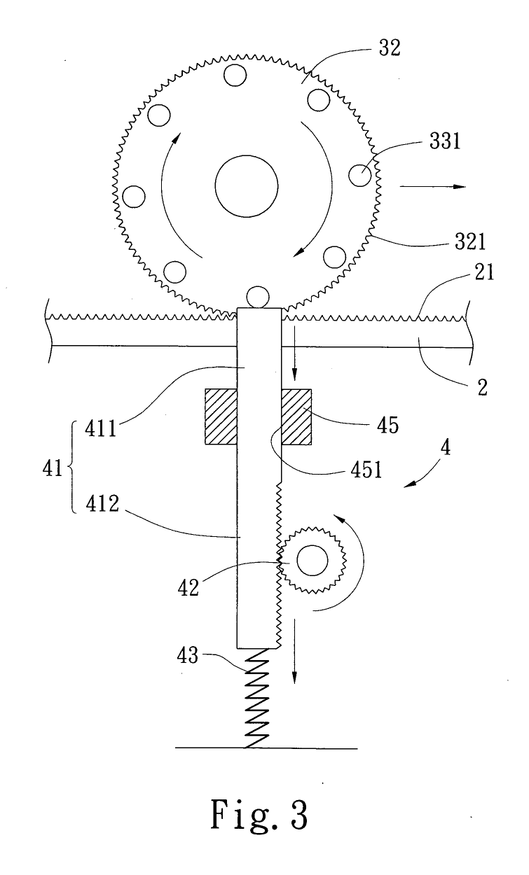

Referring to FIGS. 2 and 3 which are schematic views showing the state of use of the first embodiment of the present invention, when the power inputting device 34 drives one end of the axle rod 31 to rotate on the base 2, the other end of the axle rod 31 moves the roller 32 to roll on the base 2, the restraining and pressing rods 331 on a lateral surface of the roller 32 presses down the push-pressing portion 411 on the upper end of the slide member 41 of the moving-to-and-fro linking member 4; The moving-to-and-fro linking member 4 links up the gear 42 via the rack 412, the gear 42 in turn links up the power outputting portion 44 to output power. At this time, the elastic member 43 on the lower end of the rack 412 is in a compressed state.

When the roller 32 goes on to roll on the base 2, the push-pressing portion 411 on the upper end of the slide member 41 gets rid of the pressing of a pressing rod 331, so that the slide member 41 can restore its original position by a restoration force of the elastic member 43.

When the roller 32 rolls on the upper disc surface of the base 2, the first engaging portion 21 on the periphery of the base 2 is engaged with the second engaging portion 321 on the periphery of the roller 32 for positioning, thus a pressing rod 331 can surely press or release the push-pressing portion 411 on the upper end of the slide member 41 without the situation of inability of alignment by accumulation of errors.

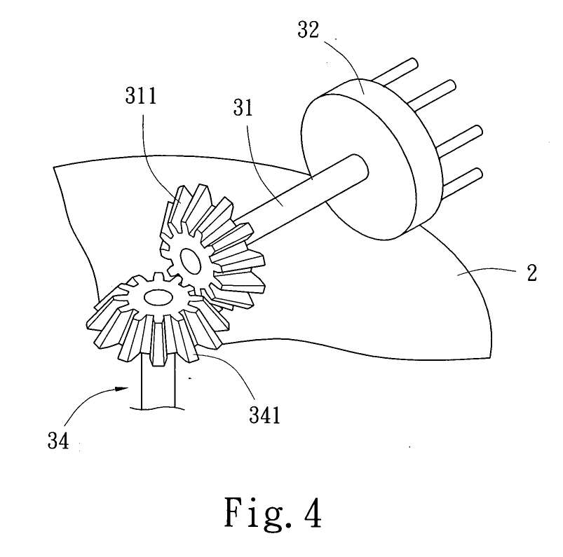

Referring to FIG. 4, in practical application of the present invention, the periphery of the roller 32 can also be a smooth surface, one end of the power inputting device 34 is provided with a gear 341 in the shape of an umbrella, while one end of the axle rod 31 is provided with a gear 311 also in the shape of an umbrella, the two gears 341, 311 in the shape of umbrellas can be engaged with each other to control the rolling rate of the roller 32 on the on the upper disc surface of the base 2.

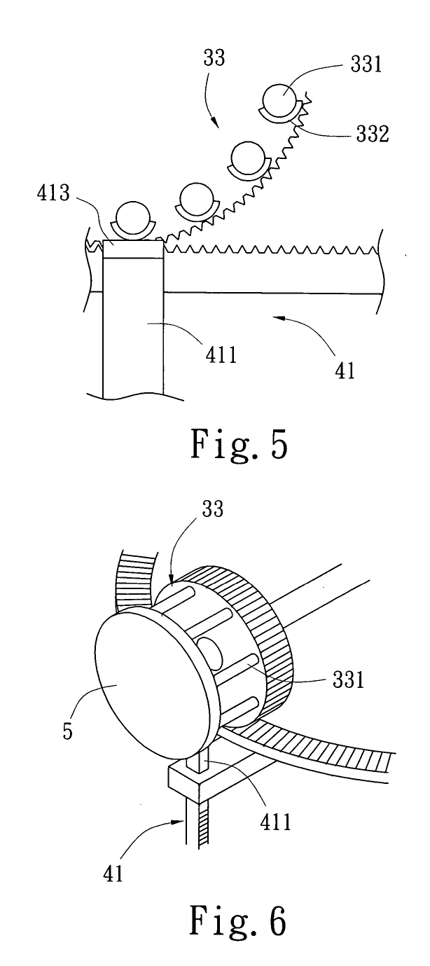

Referring to FIG. 5, each pressing rod 331 on a restraining and pressing portion 33 of the present invention can be provided with a first magnetic member 332, while the push-pressing portion 411 on the upper end of the slide member 41 of the moving-to-and-fro linking member 4 can also be provided with a second magnetic member 413; the first and the second magnetic members 332, 413 are magnets of identical polarity, thereby a repelling action force between them can reduce the friction force between the pressing rod 331 and the push-pressing portion 411.

And referring to FIG. 6, one end of the restraining and pressing portions 33 of the present invention can also be added with a fixed plate 5 in the shape of a round disc, one side face of the fixed plate 5 can be connected with a plurality of restraining and pressing rods 331 to thereby increase the strength of the restraining and pressing rods 331 to be not subjected to deformation by a reaction from the push-pressing portion 411 of the slide member 41.

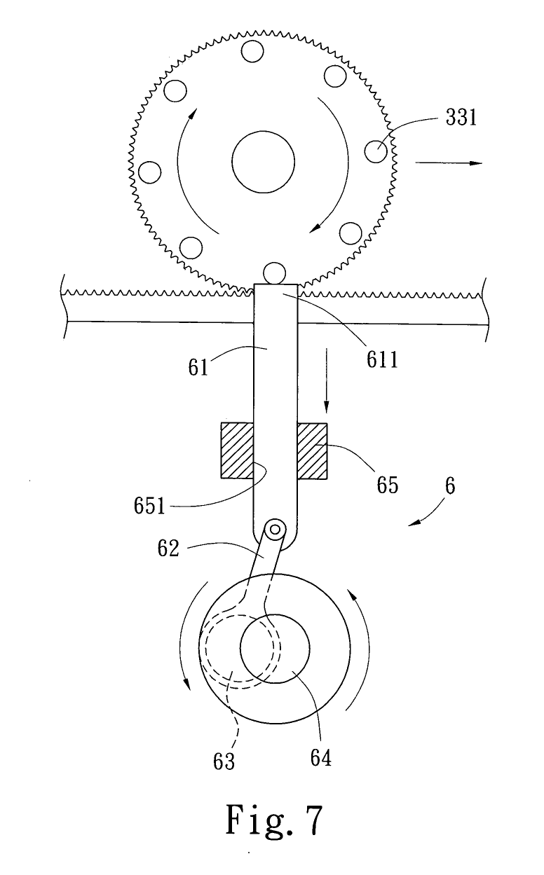

Referring to FIG. 7, the moving-to-and-fro linking member 4 can also be substituted by another structure different from any of the above stated to get the same function of transmitting. Wherein a moving-to-and-fro linking member 6 includes a moving- to-and-fro slide rod 61, a link 62, a crank axle 63 and a power outputting portion 64; the slide rod 61 is an elongate rod, it is restrained in a guiding way 651 provided in a fixed member 65 to move to and fro in the latter. The lower portion of the slide rod 61 is pivotally connected with an end of the link 62, while the other end of the link 62 is connected with the crank axle 63 that is connected with the power outputting portion 64.

When the upper end of the slide rod. 61 is pressed by a restraining and pressing rod 331, the link 62 is moved downwards to link up with the crank axle 63; then power outputting portion 64 outputs power. When the restraining and pressing rod 331 releases a push-pressing portion 611 on the upper end of the slide rod 61, the crank axle 63 can go on rotating by the inertia effect provided during rotating of the crank axle 63; thereby power can be continuously output.

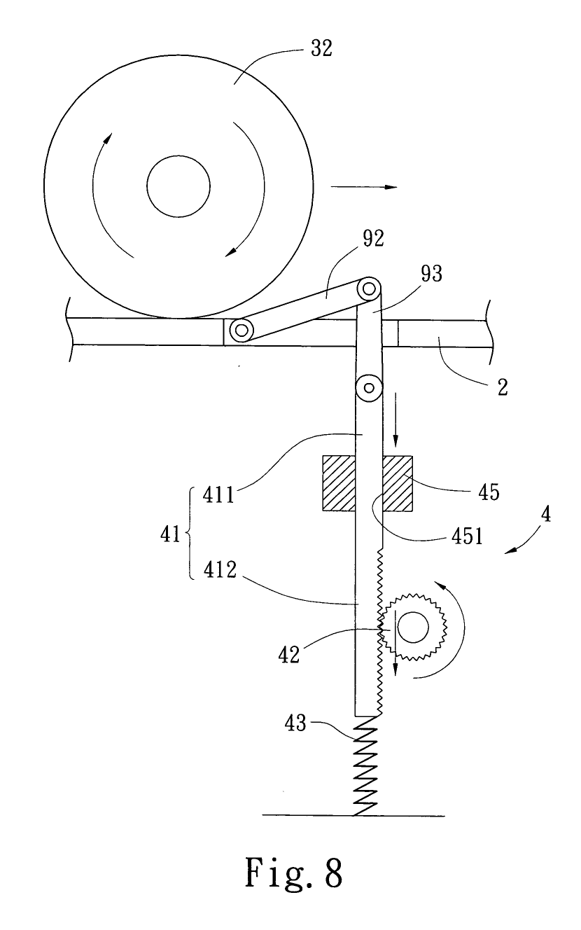

Referring to FIGS. 7-9 showing a schematic view of a second embodiment of the power generating device 1 of the present invention, wherein the moving-to-and-fro linking member 6 (8) further includes an upper linking plate 92 and a lower linking rod 93, two ends of the upper linking plate 92 are pivotally connected respectively to the base 2 and the lower linking rod 93, while the lower end of the lower linking rod 93 is pivotally connected to the push-pressing portion 411 (611); the upper linking plate 92 has an elevation angle to the base 2. When the roller 32 rolls on the upper disc surface of the base 2, by the heavy pressure exerted on the base 2 by the roller 32, the upper linking plate 92 pushes the lower linking rod 93 and the push-pressing portions 411 and 611 downwards to thereby move the moving-to-and-fro linking members 6, 8 to output power.

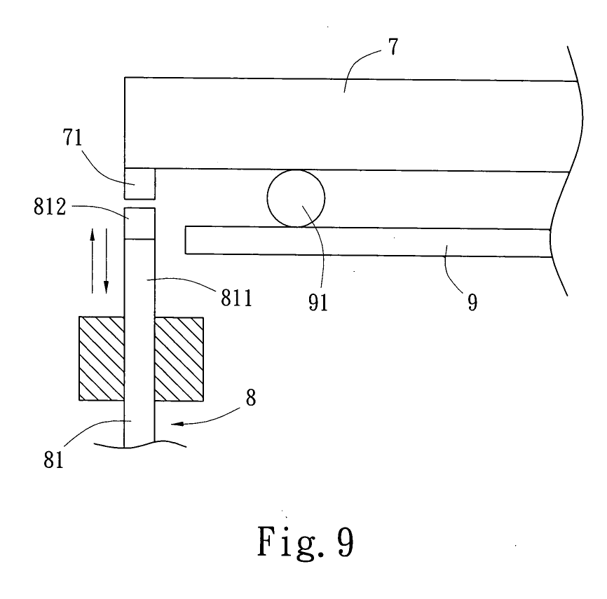

Referring to FIG. 9 showing a schematic view of a third embodiment of the power generating device 1 of the present invention, wherein a gravity pressuring device 7 is preferably a metallic round disc, the periphery of the bottom surface of the round disc 7 has a plurality of magnetic down protruding parts 71 arranged in a circle, the down protruding parts 71 are used as a restraining and pressing portion. A push-pressing portion 811 of a slide member 81 on a moving-to-and-fro linking member 8 is provided thereon with a magnetic up protruding part 812, the down protruding parts and the up protruding part 71, 812 are magnets of the same polarity. The gravity pressuring device 7 and a base 9 are provided therebetween with a plurality of rollers 91 to reduce the friction force between the gravity pressuring device 7 and the base 9 during rolling. Therefore, when the gravity pressuring device 7 is rotated on the base 9, the down protruding parts and the up protruding part 71, 812 push the push-pressing portion 811 downwards by the repelling action force generated by the identical polarities; and by linking up of the moving-to-and-fro linking member 8, the above stated effect of power outputting can also be obtained.

Therefore, the present invention has the following advantages:
1. The present invention needs only to be input with a small power to make a gravity pressurizing device with a larger weight rotated on a base, and it can obtain a power output larger than the small power input through a mechanical linking up action induced by pressing on a moving-to-and-fro linking member under the gravity of the earth.
2. The present invention is structurally simple, it is not limited concerning regional natural resources when in use, and can be widely applied to save consumption of natural resources.

In conclusion, according to the description disclosed above, the present invention surely can get the expected object thereof to provide a power generating device applicable completely to the regions all over the world to generate stable power output; therefore it has a high industrial value, what I claim as new and desire to be secured by Letters Patent of the United States is.

1. A power generating device comprising:
a base;
at least a gravity pressurizing device provided on said base and having on its one end a restraining and pressing portion;
a power inputting device connected to one end of said gravity pressurizing device to drive said gravity pressurizing device to rotate on said base; and
at least a moving-to-and-fro linking member, said moving-to-and-fro linking member is provided on one end thereof with a push-pressing portion to make said restraining and pressing portion of said gravity pressurizing device render moving after it presses downwards, a power outputting portion on the other end of said moving-to-and-fro linking member outputs energy generated by moving of said push-pressing portion.

2. The power generating device as in claim 1, wherein: said gravity pressurizing device includes an axle rod to connect with said restraining and pressing portion.

3. The power generating device as in claim 2, wherein: said restraining and pressing portion includes a roller connected to an end of said axle rod and a plurality of restraining and pressing rods combined on a lateral surface of said roller and are arranged in a circle to push said push-pressing portion on one end of said moving-to-and-fro linking member downwards.

4. The power generating device as in claim 3, wherein: said power generating device is provided with a fixed plate, one side face of said fixed plate is connected with said restraining and pressing rods arranged in said circle.

5. The power generating device as in claim 3, wherein: each of said restraining and pressing rods is provided with a first magnetic member, while said push-pressing portion of said moving-to -and-fro linking member is provided with a second magnetic member; said first and second magnetic members are magnets of identical polarity.

6. The power generating device as in claim 3, wherein: said base is provided on its periphery with a first engaging portion, said roller on said gravity pressurizing device is provided on its periphery with a second engaging portion to be engaged with said first engaging portion for positioning.

7. The power generating device as in claim 1, wherein: said moving-to-and-fro linking member includes a moving-to- and-fro slide member, a gear, an elastic member and a power outputting portion; an upper portion of said slide member is said push-pressing portion, while a lower portion of said slide member is a rack; said rack is engaged with said gear, an end of said rack is connected with said elastic member; said gear is connected with said power outputting portion.

8. The power generating device as in claim 1, wherein: said moving-to-and-fro slide member includes a moving-to-and-fro slide rod, a link, a crank axle and a power outputting portion; an upper portion of said slide rod is said push-pressing portion, while a lower portion of said slide rod is pivotally connected with an end of a link, while the other end of said link is connected with a crank axle that is connected with said power outputting portion.

9. The power generating device as in claim 7, wherein: said moving-to-and-fro linking member further includes an upper linking plate and a lower linking rod, two ends of said upper linking plate are pivotally connected respectively to said base and said lower linking rod, while a lower end of said lower linking rod is pivotally connected to said push-pressing portion.

10. The power generating device as in claim 8, wherein: said moving-to-and-fro linking member further includes an upper linking plate and a lower linking rod, two ends of said upper linking plate are pivotally connected respectively to said base and said lower linking rod, while a lower end of said lower linking rod is pivotally connected to said push-pressing portion.

11. The power generating device as in claim 1, wherein: said restraining and pressing portion on one end of said gravity pressurizing device at least has a magnetic down protruding part, a magnetic up protruding part is pivotally connected to said push-pressing portion, said down protruding parts and said up protruding part are magnets of same polarity.

12. The power generating device as in claim 1, wherein: said gravity pressuring device and said base are provided therebetween at least with a roller.
